(19) United States
(12) Patent Application Publication
(10) Pub. No.: US 2005/0152523 A1
(43) Pub. Date: Jul. 14, 2005

(54) Method and system for enhanced management of telephone conferences

(75) Inventors: Craig William Fellenstein, Brookfield, CT (US); Leslie Mark Ernest, Knoxville, MD (US); Rick Allen Hamilton II, Charlottesville, VA (US); James Wesley Seaman, Falls Church, VA (US)

Correspondence Address: Darcell Walker;Suite 250, 9301 Southwest Freeway, Houston, TX, 77074, US

(73) Assignee: International Business Machines Corporation, Armonk, NY (US)

(21) Appl. No.: 10/755,830

(22) Filed: Jan. 12, 2004

(51) Int. Cl. H04M 3/42

(52) U.S. Cl. 379/202.01

(57) ABSTRACT

This present invention provides a teleconferencing method and system in which that places the contact responsibility on the conference host, rather than passively requiring individuals to connect to the conference. This invention creates a participant profile for each potential conference participant. The user profile would include a primary point of contact, such as an office telephone, and secondary choice, such as a home office telephone, cellular telephone, or text capable Personal Digital Assistant (PDA). As the system proceeds through the options, in the event the participant is not reached, a message appropriate to that media (voicemail, text message, etc.) can be left as a reminder. Further, the invention would provide to all participants any softcopy materials deemed critical by the leader of the meeting, in a format based on user preferences also contained in the profile database.

### FIELD OF THE INVENTION

This invention relates to a method and system for monitoring the events of a teleconference meeting and in particular to a method and system for managing telephone conferences by using a hierarchy of user profiles for conference call participants in a proactive manner to maximize telephone conference participation and productivity.

### BACKGROUND OF THE INVENTION

In the 21^{st} century, companies are conducting more business in a mobile environment. In many organizations, employees, colleagues and managers are spread out across the United States and around the globe. Therefore, many meetings are being conducted over the telephone and computer networks such as the Internet using communications companies like telecom giants AT&T, MCI, Sprint and software such as Microsoft's NetMeeting® or IBM's e-Meeting.

It is a well-known fact that today's workforce is becoming increasingly mobile. Traditional face-to-face meetings are becoming a rare event, replaced in large part by multi-party conferences, using a variety of media—traditional conference call, e-meetings, web cams with audio, instant messaging and others. Coupled with a constant drive to increase individual productivity, many workers have multiple conferences throughout the day. It is not unusual for some people to spend upwards of 50-60 percent of their workday participating in these conferences. As a result of these new dynamics in the workplace, traditional conference call technology is becoming woefully inadequate.

It is not at all atypical for conferences involving 6 to 12 people to start late by 5 to 10 minutes, or more waiting for one or two critical, but tardy, callers, resulting in significant lost productivity. Frequently, individuals do not come to the call prepared with all required materials, causing additional delays while people access individual file repositories or search team rooms. Callers frequently do not avail themselves to the lowest cost option for dialing in to a call, resulting in increased costs. Lastly, conference call leaders may not provide summaries of calls and decisions reached, resulting in increased costs. Lastly, conference call leaders may or may not provide summaries of calls and decisions reached, resulting in even more rework and lost productivity. While team rooms and other collaboration attempts to solve this problem, all current solutions are passive, requiring overt action on the part of the callers.

A basic service offered by telecommunications companies is to provide a communications connection between at least two parties for a certain period of time. The process of providing this telecommunications service can be described conceptually as arranging a telecommunications meeting between the participants (i.e., a so-called “telemeeting” or “telephone conference”). Ever since the emergence of this telemeeting concept, a number of pertinent questions have been raised, such as: How is it possible for a communications network manager to (1) effectively manage a telemeeting involving numerous participants, (2) control participation in a telemeeting (e.g., should the meeting be open to anyone), (3) enable participants to join a telemeeting from any location, and (4) schedule a telemeeting in terms of both time and place? Inevitably, in a conventional heterogeneous communications environment, telemeeting participants will attempt to gain admittance to a session in a number of different ways. However, from a conference planning and management standpoint, conventional communication networks are unable to determine beforehand the number of participants and how and where individual participants will be attempting to gain admittance to such a telemeeting.

Teleconferencing is one basic service offered by conventional telecommunications companies whereby a limited number of participants can confer simultaneously with each other. However, the basic services now being offered typically do not offer any type of conference management support. In other words, the person who has asked for and initiated the telemeeting makes the communication connections between the conference participants. Typically, the person initiating the meeting notifies each participant in turn, which requires prior knowledge of information about the participant.

The current technology allows an initiator/host such as a project manager to hold a conference call for a group such as a project team of twenty members. Before the call begins, each member receives a reminder notice with dial-in number, time and pass code. As a call is being conducted, when a participant signs in, the conference call is alerted with a beep or the project manager waits for all to sign in and take roll. In the former situation, the beep sound when a participant enters or leaves the conference is very disruptive. In this latter situation, it can be very time-consuming not only for the host but also those attending the call.

Normally, when there is a telephone conference, it is necessary to go through a moderator or a telephone company such as AT&T. A moderator is an online telephone company representative. This representative moderates the call, which can include performing services such as tracking the list of participants calling into the meeting and giving permission to participants to speak during the meeting.

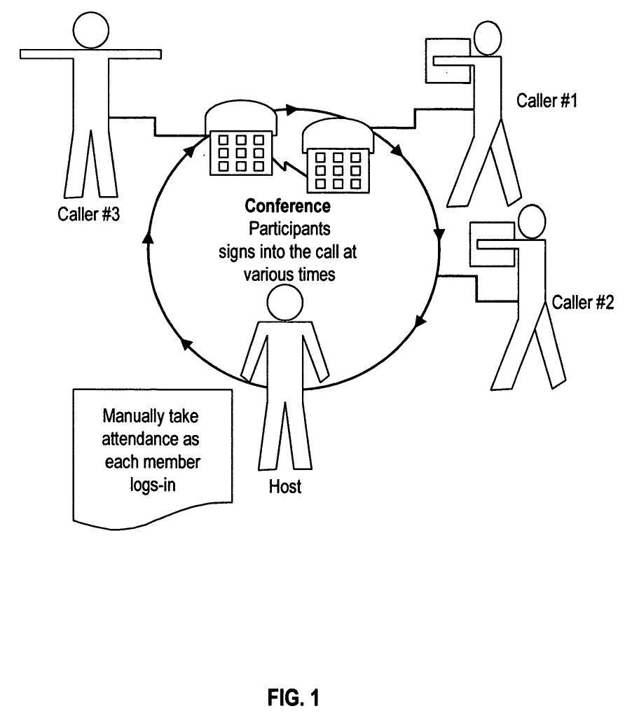

As shown in FIG. 1, a conventional conference call configuration incorporates a host or moderator that controls the conducting of the meeting. The conference host could perform the tasks of the moderator. The role of the moderator includes several tasks. One task is to monitor which participants from an initial list of invited participants has called into the meeting. This task is one of attendance checking. The moderator would inform the meeting host when a participant has called into the meeting or has left the meeting. Another task can be to grant speaking permissions to the participants during the meeting. In the performance of this task, the moderator could mute out lines of those participants that do not have the permission to speak and allow only certain participants to speak that have the speaking permission. The moderator could also generate statistics of the meeting at the conclusion of the meeting. However, with a moderator, the original conference host may have to spend extra time and incur additional monetary costs in order to coordinate the meeting with the moderator.

There have been many ideas implemented to improve the process of connecting parties that want to participate in telephone meetings. One such idea is a teleconferencing system disclosed in U.S. Pat. No. 5,369,694, which is entitled “Unattended Meet-Me-Conference Controlled By A Telephone Terminal.” Essentially, this patent discloses a method for automatically connecting teleconference participants who can register for the conference by calling a predetermined telephone number. A telephone terminal (capable of executing application software programs) provides certain teleconferencing management and control functions, and uses control signals to communicate with the telecommunications network and establish connections for all conference participants. The disclosed system employs a modified Integrated Services Digital Network (ISDN) protocol to control the transfer of signaling and speech data. However, a problem with such a system is that special “intelligent” terminal equipment is required, which can limit the ultimate use of the service provided. Also, the use of an ISDN protocol can be technically and/or financially prohibitive for certain network operators. Furthermore, in order to obtain a global level of service with conventional methods, the necessary and proper ISDN protocol would be required in all networks through which conference participants connect to a conference.

The current telephone services available for conference calls are not efficient for all involved. The problem arises because the responsibility for initiating the connection to the call rests with the actual participants. As expected participants login/connect at different times. Though meeting notices are sent out early and participants are recommended to be on time, it is still merely impractical and unfeasible to require everyone to be at a meeting at an exact time in today's dynamic business world or pose restrictions not allowing others to dial in after the meeting has started. These limitations simply will not work for many attendees for reasons like meeting overlaps, time zone issues, or people joining the conference call from different locations in the world.

The result of hosting a meeting with a diverse group of participants is the initiator/moderator ends up spending an excessive amount of time taking attendance instead of focusing on the discussion. The telephone conference is continuously interrupted as other participant joins or leaves the conference call, typically makes a beeping noise that interrupts the discussion and disturbs the meeting.

The original goal of holding conference calls is to conduct business matters in an effective and efficient manner. With the current technology available, excessive time is spent on taking attendance or as each person logs into the call, the meeting gets interrupted. Therefore, it is a market need for a method and system solution that can address the issues associated with the inefficient use of teleconferencing. A proper solution could limit teleconferencing cost issues through the effective use of teleconferencing.

### SUMMARY OF THE INVENTION

It is an objective of the present invention to provide a method and system for managing the events of a telephone conference meeting.

It is a second objective of the present invention to provide a method and system in which the task of connecting with a telephone conference meeting is placed with the individual conference participants rather than the initiator of the meeting.

It is a third objective of the present invention to provide a method and system for creating a hierarchical user profile for each participant of a conference call.

It is a fourth objective of the present invention to provide method and system for sending a message to telephone conference participants that can be reached prior to a scheduled telephone conference meeting.

It is fifth objective of the present invention to provide a user profile, which has an interface for both conference participants and conference initiator.

It is a sixth objective of the present invention to provide a method and system that can reduce the cost of a telephone conference searching for the lowest cost option for contacting telephone conference participants.

It is a seventh objective of the present invention to provide a method and system to efficiently schedule a teleconference.

This invention attempts to solve these problems by actively pushing conference contact out to the conference participants, rather than passively requiring individuals to connect to the conference. It determines the lowest cost option based on a number of personalization factors contained in a pre-established user profile database, telephone rate schedules and date/time of the conference. The user profile would include a primary point of contact, such as an office telephone, and secondary choice, such as a home office telephone, cellular telephone, or text capable Personal Digital Assistant (PDA). As the system proceeds through the options, in the event the participant is not reached, a message appropriate to that media (voicemail, text message, etc.) can be left as a reminder. Further, the invention would provide to all participants any softcopy materials deemed critical by the leader of the meeting, in a format based on user preferences also contained in the profile database. Conference participants would also still retain the ability to attach to the conference proactively, using whatever device is most appropriate to their circumstances.

The advantage of this solution is that all conference participants (including web sessions using web cams and audio connect) would be contacted simultaneously, increasing the likelihood that the call will start on-time, and all users having required materials. While there are a number of alarm options such as reminders in e-mail calendars or PDA's, these can be missed of ignored. The present invention attempts to reach individuals using their preferred technology.

### DETAILED DESCRIPTION OF THE INVENTION

FIG. 1 is a configuration for a conventional telephone conference meeting where participants call in to establish a connection into the meeting.

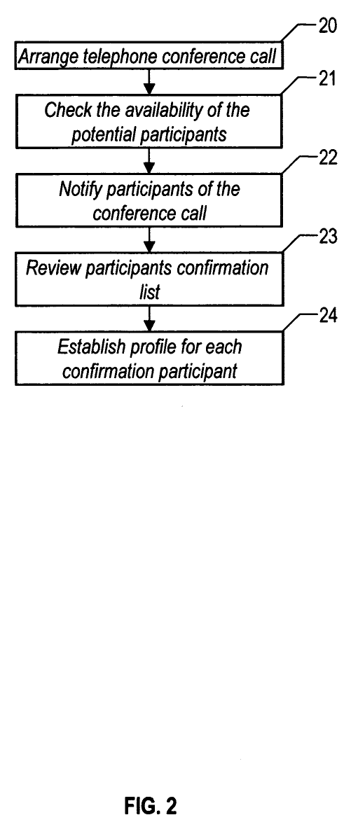

FIG. 2 is a flow diagram of the initial steps in the implementation of the present invention.

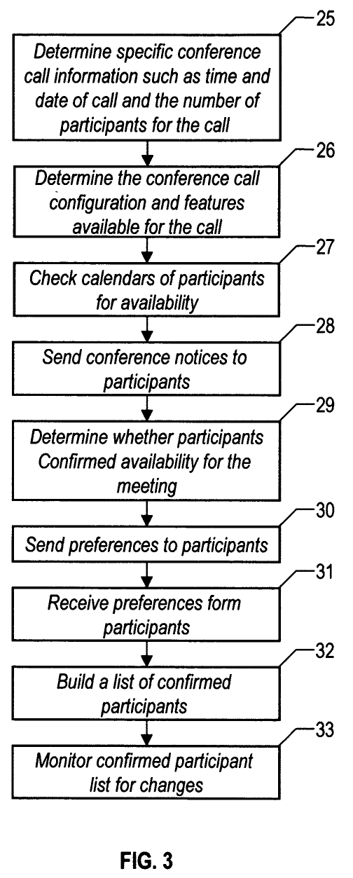

FIG. 3 is a flow diagram of the activities involved in the implementation of the present invention.

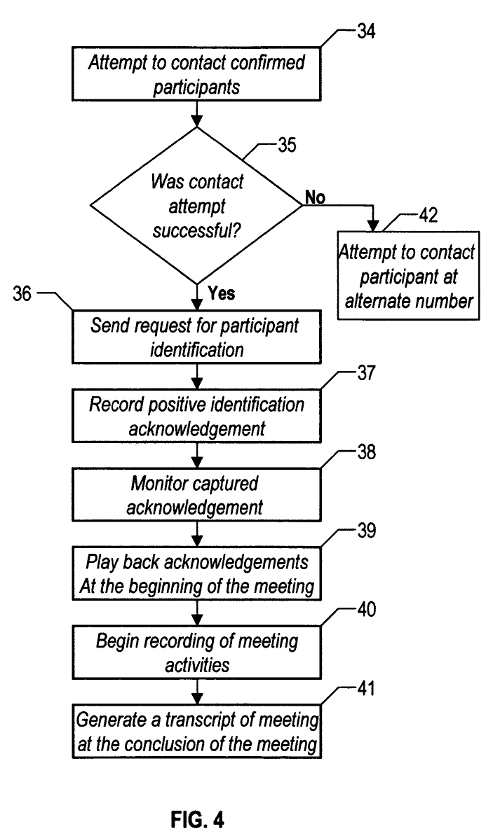

FIG. 4 is a flow diagram of the connecting and monitoring steps of the present invention.

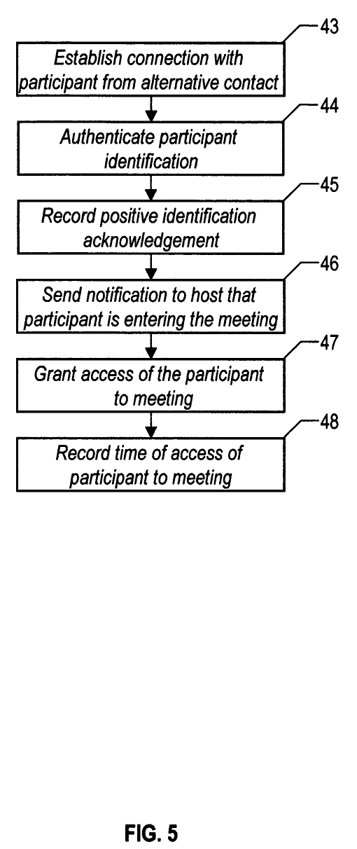

FIG. 5 is a flow diagram of the steps involved in an alternate method for contacting a participant when the host of the teleconference is unable to contact the participant via the primary contact device.

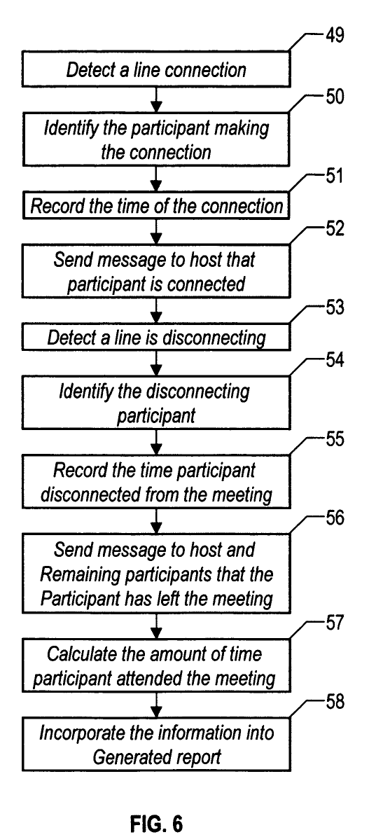

FIG. 6 is a flow diagram for monitoring the activities of the meeting and responding to and recording of events that occur during the meeting.

### DETAILED DESCRIPTION OF THE INVENTION

The present invention provides an improved method and system for conducting telephone conference meetings. This invention allows for the automatic monitoring, tracking and recording of meeting data that was not previously collected or was done manually. The method of the present invention can be implemented with software housed in the host computer or at the local telephone carrier. This software would perform tasks such as assigning identification numbers to meeting participants, monitoring participant access and departure times and generating a report of the activities of the meeting at the conclusion of the meeting. The meeting host initiates the connections with the participants in the meeting. This approach is a reversal from the conventional method of the participants calling in the host. The software at the host location of a carrier location controls the various activities of the meeting. At the completion of the meeting, a report is generated and sent to the meeting initiator.

The core of this invention is the user profile database, with an interface for both conference participants and conference leaders. Users pre-register with the conference system, establishing a profile which designates their preferred contact numbers of devices, in descending sequence of priority. Referring to FIG. 2, when the host wishes to convene a meeting, in step 20, the host first arranges the telephone conference call. This task involves selecting the date/time for the conference, and selecting the persons who will participate in the call who is to participate by selecting names from the database, with the option to add names/numbers for individuals not currently in the database. In step 21, the method of the present invention then automatically checks available electronic calendars to confirm availability, presenting the host with additional options should all individuals not be available at the original date/time, using currently available calendaring techniques. After a review of the participant availability, in step 22, the host notifies the participants of the conference call. The next activity in step 23 is the review the confirmations from the notified participants. After receiving a confirmation from a notified participant, step 24 establishes a profile of the confirmed participant. The participant profile will contain information related to the various means to contact the participant. As mentioned, this profile can be stored in a database location. In some cases, there will already be a profile of the confirming participant stored in the database. However, it may still be necessary to update the information in the database for that participant.

FIG. 3 illustrates a flow diagram of the activities involved in the implementation of the present invention. As previously mentioned, in step 25 there is determination of the specific conference call information. This information can include the time and date of the call, the number of persons to participate in the call and the names of the actual participants. In step 26, the host will determine the features that will be used to monitor, control and track the activities of the call. The host will typically consult with a representative of the telephone carrier to make these decisions. Once the host has determined the list participants for the call, step 27 will automatically check the calendars of the listed participants to their availability at the scheduled time for the call. Information on the calendars of participants can also be stored in the database with the other information on the participants. Based on the results of the availability of the participants, step 28 will send meeting notifications to the available participants.

Once the notices are sent to the participants, participants will respond to the notice and confirm whether they can attend the conference call meeting. The meeting notices in step 28 and the responses will usually be via electronic mail. Step 29 will monitor the responses of the participants to determine which persons will available to participate in the meeting. If a participant is available, step 30 will send a request for preferences from the participant. When the conference invitation goes out, users who accept the invitation are also presented with their preferences, allowing them to select their preferred connectivity option based on their anticipated schedule for that day. Optionally, the users can elect to have a reminder sent out periodically in advance of the conference to whatever technology they prefer. They can also update/change their original choice, should their schedules change between the time they accept the invitation and the actual event. These preferences will also be for the purpose of determining the number of contact devices for the participant and the priority of these contact devices. For example, the participant may have list three devices such as cellular telephone, email address and a personal digital assistant (PDA). In step 31, the participant will send this information to the host. As the host location receives the responses from the notified participants, step 32 builds a list of participants conformed for the meeting. At this point, step 33 monitors the list of confirmed participants in the event the information supplied by a participant changes. The implementation of this step could be by sending period update queries to the confirmed participants.

The acknowledgements from potential participants accepting the invitation are fed into the system, which builds a list of confirmed conference participants. The host of the meeting/conference can periodically review this list until all critical attendees have accepted, or receive pushed updates as each proposed participant declines or accepts. At an adjustable time prior to the conference, selected by the leader, the system attempts to contact the participants at their preferred number or contact point, using the lowest cost option (tie line, 800 number, local, etc). If the users are not at their preferred contact point, the system will automatically attempt to reach them at their optional contact points. The system also sends a URL for any required materials, supplied by the conference leader, to these same participants, based on preferences captured when the participant accepted the invitation.

FIG. 4 is a flow diagram of the connecting and monitoring steps of the present invention at the time of the meeting. In step 34, there is an attempt by the host to contact each confirmed participant. Step 35 will monitor and determine whether there is a connection established between host and a participant. This step can comprise detecting the establishment of the connection with a participant. If there is a successful connection, the process moves to step 36. As participants are reached by the system, in step 36, the participants are asked to identify and authenticate themselves to the system. Step 37 records successful authentications at the host location. The method of authentication can be of any conventional means. The conference leader can monitor the acknowledgements as they are captured, step 38, so the host may know when critical participants have been reached and are available to participate. The acknowledgement could be in the form of having a participant say their name orally. This oral statement can be recorded to capture a sample of the participant's voice pattern. Under control of the conference leader, at the initiation of the call, in step 39, the system plays back the callers' acknowledgements to so that all participants know who is on the conference call. Step 40 starts the recording of meeting activities. Voice recognition software records to a file on the system containing the registration database of participant voices. At the completion of the conference, step 41 generates a transcript and provides a copy of the transcript to all participants, including those unable to make the conference, under control of the conference leader. Referring back to step 35, if the initial attempt to contact the participant is unsuccessful, the method moves to step 42. In this step, there are additional attempts to contact the participant using one of the other listed devices for that participant. After the attempt in step 42, the process moves to step 35, where there is a determination of whether the attempt was successful. If the additional attempt was successful, the process continues on to step 37. If the additional attempt was not successful, the process again moves to step 42. This loop continues until there is a successful connection or the list of alternate contact devices is exhausted in step 42. If this process does not produce a successful connection, the host is notified of this situation and the process ends for this participant.

FIG. 5 is a flow diagram of the steps involved in an alternate method for contacting a participant when the host of the teleconference is unable to contact the participant via the primary contact device. Step 43 attempts to connect with an alternate device from the list of devices supplied by the participant in step 31. Once the connection is established, the method moves to step 44, which authenticates the participant identification similar to step 36. The positive authentication of the participant is recorded in step 45. At this point, in step 46, the system sends notification to the host that a participant is entering the meeting. The host and other participants learn of the entry of the new participant. At the completion of the notification, step 47 grants access to the new participant. Step 48 records the time the participant entered the meeting.

If the authentication of the participant is prior to the beginning of the meeting, the access of the participant would be treated the same as if the initial access attempt was successful. Referring back to FIGS. 4 and 5, if step 43 established a connection with an alternate contact device for a participant, a step could be added to check the current time. If the meeting had not begun, the process would move to step 36 of FIG. 4 and continue as described in FIG. 4.

FIG. 6 illustrates a flow diagram for monitoring the activities of the meeting and responding to and recording of events that occur during the meeting. This process can track who attended the meeting, the time a participant entered the meeting, and when a participant left the meeting. This information would be included in the report generated at the end of the meeting.

In this process, step 49 would detect the establishment of a connection of the host with a participant. Step 50 would identify the participant. At this time, the participant authentication process would verify the identity of the participant. Step 51 would record the actual time the connection was established with the participant. During these conference call meetings it is not usual for a participant to connect to the meeting while the meeting is in process. In this situation, a message is sent to the host and participants that a new participant has joined the meeting, step 52. The message would contain the identity of the new participant. This connection could be established without interrupting the meeting, which often occurs when some joins or leaves a meeting.

As mentioned, it is common for someone to disconnect from conference call meeting before the end of the meeting. In the process illustrated in FIG. 6, step 53 would detect when a participant disconnected from the meeting. As with step 50, step 54 would identify the disconnecting participant. Step 55 would record the time of the disconnection. The host and other participants would receive a message informing them that the participant had disconnected from the meeting. This notice would occur in step 56. At this point, step 57 would calculate the amount of time the disconnecting spent in the meeting. Step 58 would incorporate this information into the report generated at the completion of the meeting.

The features of the present invention provide considerable advantages over conventional teleconferencing systems. By placing the task of initiating the connection call with the host instead of with the individual participants, the efficiency of connecting the participants and beginning the meeting in a timely manner is greatly improved. In addition the creation of a participant profile with alternate means of contacting the participant will aid in ensuring maximum participation in the meetings.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

Having thus described the invention, what we claims as new and desire to secure by Letters Patent is set forth in the following claims.

1. A method for managing the activities of a teleconference meeting comprising the steps of:
notifying potential participants of a teleconference meeting;
creating a profile of potential teleconference meeting participants;
initiating a connection attempt with each participant at the host and establishing a connection with each participant prior to the beginning of the teleconference meeting;
monitoring the activities occurring during the teleconference meeting; and
generating a report of the activities that occurred during the telephone meeting at the end of the meeting.

2. The method as described in claim 1 wherein said participant profile creation step further comprises:
gathering information about the alternative means for contacting the participant; and placing this information in a storage location for access as needed by the host of the teleconference meeting.

3. The method as described in claim 1 further comprising after said participant notifying step, the step of determining which participants have confirmed availability for the meeting.

4. The method as described in claim 2 wherein the telephone meeting information comprises the time of the meeting, the date of the meeting and the number of participants attending the meeting.

5. The method as described in claim 2 wherein said information gather step further comprising sending each confirming participant a request for alternative contact information.

6. The method as described in claim 5 wherein said contact information includes a priority list of alternative contact means of the participant.

7. The method as described in clam 1 further comprising the step of building a list of confirmed participants.

8. The method as described in claim 7 further comprising after said list building step, the step of monitoring the confirmed participant list for changes to the gathered alternative contact information of the participant or the participant's availability for the meeting.

9. The method as described in claim 1 further comprising after said call initiating step, the steps of:
determining whether a successful connection was established with a participant during the call attempt; and
initiating a call attempt to alternative contact device for that participant when the previous call attempt to establish a connection was unsuccessful.

10. The method as described in claim I further comprising after said call initiating step, the steps of:
determining whether a successful connection was established with a participant during the initial call attempt;
authenticating the participant identification when the connection attempt was successful;
capturing acknowledgements from connected participants; and
playing back the captured acknowledgements at the start of the meeting.

11. The method as described in claim I further comprising simultaneously with said monitoring step, the step of recording the activities of the meeting.

12. A computer program product in a computer readable medium for use in managing the activities of a teleconference meeting comprising:
instructions for notifying potential participants of a teleconference meeting;
instructions for creating a profile of potential teleconference meeting participants;
instructions for initiating a connection attempt with each participant at the host and establishing a connection with each participant prior to the beginning of the teleconference meeting;
instructions for monitoring the activities occurring during the teleconference meeting; and
instructions for generating a report of the activities that occurred during the telephone meeting at the end of the meeting.

13. The computer program product as described in claim 12 wherein said participant profile creation instructions further comprise:
instructions for gathering information about the alternative means for contacting the participant; and placing this information in a storage location for access as needed by the host of the teleconference meeting.

14. The computer program product as described in claim 12 further comprising after said participant notifying instructions, instructions for determining which participants have confirmed availability for the meeting.

15. The computer program product as described in claim 13 wherein said information gather instructions further comprise instructions for sending each confirming participant a request for alternative contact information.

16. The computer program product as described in clam 12 further comprising instructions for building a list of confirmed participants.

17. The computer program product as described in claim 16 further comprising after said list building instructions, instructions for monitoring the confirmed participant list for changes to the gathered alternative contact information of the participant or the participant's availability for the meeting.

18. The computer program product as described in claim 12 further comprising after said call initiating instructions:
instructions for determining whether a successful connection was established with a participant during the call attempt; and
instructions for initiating a call attempt to alternative contact device for that participant when the previous call attempt to establish a connection was unsuccessful.

19. The computer program product as described in claim 12 further comprising after said call initiating instructions:
instructions for determining whether a successful connection was established with a participant during the initial call attempt;
instructions for authenticating the participant identification when the connection attempt was successful;
instructions for capturing acknowledgements from connected participants; and
instructions for playing back the captured acknowledgements at the start of the meeting.

20. The computer program product as described in claim 12 further comprising simultaneously with said monitoring instructions, instructions for recording the activities of the meeting.
